(19) United States
(12) Patent Application Publication
(10) Pub. No.: US 2016/0003692 A1
(43) Pub. Date: Jan. 7, 2016

(54) Method of Operating a Mobile Device, Computer Program Product and Mobile Device

(71) Applicant: NXP B.V., Eindhoven (NL)

(72) Inventors: Pei Sin Ng, Singapore (SG); Jinquan Huang, Singapore (SG); Kim Phan Le, Eindhoven (NL); Cheng Leong Lim, Singapore (SG)

(21) Appl. No.: 14/747,359

(22) Filed: Jun. 23, 2015

(30) Foreign Application Priority Data
Jul. 1, 2014 (EP) 14175230.3

(51) Int. Cl. G01K 15/00; H04M 1/02

(52) U.S. Cl. CPC G01K 15/00; H04M 1/026

(57) ABSTRACT

There is disclosed a method of operating a mobile device, wherein: a temperature sensor comprised in said mobile device measures, at a first time instant, an initial temperature value; the temperature sensor measures, at a second time instant, a current temperature value; a processing unit comprised in said mobile device calculates an ambient temperature around the mobile device in dependence on the initial temperature value, the current temperature value and at least one further value which is indicative of a thermal influence of a mobile device component on the temperature sensor. Furthermore, a corresponding computer program product is disclosed, as well as a corresponding mobile device.

### CROSS-REFERENCE TO RELATED APPLICATIONS

This application claims the priority under 35 U.S.C. §119 of European patent application no. 14175230.3, filed Jul. 1, 2014 the contents of which are incorporated by reference herein.

### FIELD

The present disclosure relates to a method of operating a mobile device.

Furthermore, the present disclosure relates to a corresponding computer program product and to a corresponding mobile device.

### BACKGROUND

Modern mobile devices, such as smart phones, often contain temperature sensors which are used to measure the ambient temperature around said devices. However, the temperature sensors within such mobile devices should ideally be placed as close as possible to the medium whose temperature should be measured, i.e. the ambient air, in order to yield reliable measurement results. However, temperature sensors can only be housed within the body of a mobile phone, for cosmetic and functional reasons. Unfortunately, temperature sensors placed within a casing or enclosure exhibit a relatively large response time. That is to say, it takes a relatively large amount of time, for example 15 to 40 minutes, before an embedded temperature sensor accurately measures the ambient air temperature. It may be desirable to reduce this response time. Furthermore, it may be desirable to provide, to a user of a mobile device, an indication of an environmental condition around the mobile device.

### SUMMARY

There is disclosed a method of operating a mobile device, wherein: a tempera-tore sensor comprised in said mobile device measures, at a first time instant, an initial temperature value; the temperature sensor measures, at a second time instant, a current temperature value; a processing unit comprised in said mobile device calculates an ambient temperature around the mobile device in dependence on the initial temperature value, the current temperature value and at least one further value which is indicative of a thermal influence of a mobile device component on the temperature sensor.

In one or more illustrative embodiments, the processing unit calculates the ambient tempera-tore in dependence on a further value that is indicative of a thermal influence of a sensor package which includes the temperature sensor.

In one or more further illustrative embodiments, the processing unit calculates the ambient temperature in dependence on a further value that is indicative of a thermal influence of a printed circuit board on which the sensor package is mounted.

In one or more further illustrative embodiments, the processing unit calculates the ambient temperature in dependence on a further value that is indicative of a thermal influence of a casing of the mobile device.

In one or more further illustrative embodiments, the processing unit calculates the ambient temperature further in dependence on a ratio which is indicative of respective contributions of thermal influences of different mobile device components on the temperature sensor.

Furthermore, there is disclosed a method of operating a mobile device, wherein: a temperature sensor measures a plurality of temperature values; and a processing unit determines an environmental condition around the mobile device by: determining a rate of change of the measured temperature values, comparing the determined rate of change with a plurality of different reference values corresponding to predefined environmental conditions, selecting the reference value which is closest to the determined rate of change, and concluding that the environmental condition around the mobile device is the same as the predefined environmental condition which corresponds to the selected reference value.

In one or more illustrative embodiments, each of the plurality of different reference values is included in one of a plurality of thermal profiles.

In one or more further illustrative embodiments, at least one predefined environmental condition corresponds to a weather condition and/or at least one predefined environmental condition corresponds to a surrounding material condition.

Furthermore, there is disclosed a computer program product comprising executable instructions which, when being executed by a processing unit, carry out or control a method of the kind set forth.

Furthermore, there is disclosed a mobile device comprising: a temperature sensor being arranged to measure, at a first time instant, an initial temperature value and, at a second time instant, a current temperature value; a processing unit being arranged to calculate an ambient temperature around the mobile device in dependence on the initial temperature value, the current temperature value and at least one further value which indicative of a thermal influence of a mobile device component on the temperature sensor.

In one or more illustrative embodiments, the processing unit is arranged to calculate the ambient temperature in dependence on a further value that is indicative of a thermal influence of a sensor package which includes the temperature sensor.

In one or more further illustrative embodiments, the processing unit is arranged to calculate the ambient temperature in dependence on a further value that is indicative of a thermal influence of a printed circuit board on which the sensor package is mounted.

In one or more further illustrative embodiments, the processing unit is arranged to calculate the ambient temperature in dependence on a further value that is indicative of a thermal influence of a casing of the mobile device.

In one or more further illustrative embodiments, the processing unit is arranged to calculate the ambient temperature further in dependence on a ratio which is indicative of respective contributions of thermal influences of different mobile device components on the temperature sensor.

Furthermore, there is disclosed a mobile device comprising a temperature sensor and a processing unit, wherein the temperature sensor is arranged to measure a plurality of temperature values; and wherein the processing unit is arranged to determine an environmental condition around the mobile device by: determining a rate of change of the measured temperature values, comparing the determined rate of change with a plurality of different reference values corresponding to predefined environmental conditions, selecting the reference value which is closest to the determined rate of change, and concluding that the environmental condition around the mobile device is the same as the predefined environmental condition which corresponds to the selected reference value.

### DESCRIPTION OF DRAWINGS

Embodiments will be described in more detail with reference to the appended drawings, in which:

FIG. 1A shows an illustrative embodiment of a method of operating a mobile device;

FIG. 1B shows an illustrative embodiment of a corresponding mobile device;

FIG. 2 illustrates the effect of applying a method of operating a mobile device of the kind set forth;

FIG. 3 illustrates the effect of varying environmental conditions on temperature change.

### DESCRIPTION OF EMBODIMENTS

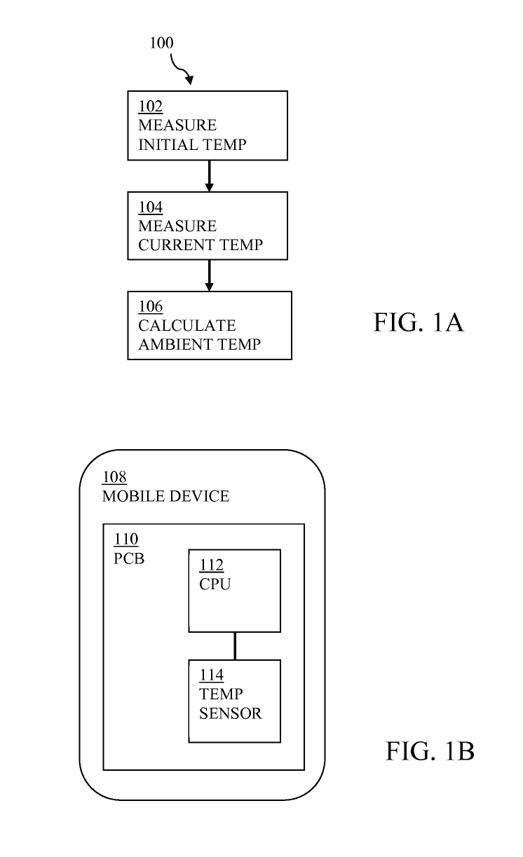

FIG. 1A shows an illustrative embodiment of a method 100 of operating a mobile device in accordance with the present disclosure. An initial temperature value is measured, at 102, by a temperature sensor comprised in the mobile device, at a first time instant. Then, at 104, a further temperature value is measured, at a second time instant. Next, an ambient temperature around the mobile device is calculated, at 106, in dependence on the initial temperature value, the current temperature value and at least one further value which is indicative of a thermal influence of a mobile device component on the temperature sensor. For example, as explained below, the thermal influence of the sensor package, the printed circuit board on which the sensor package is mounted, and the casing of the mobile device may be taken into account. A computer program may carry out or control the steps of the method. In this way, the ambient temperature around the mobile device may be approximated relatively fast.

FIG. 1B shows an illustrative embodiment of a corresponding mobile device 108. The mobile device 108 may comprise a printed circuit board 110, for example, on which a central processing unit 112 may be provided, as well as a temperature sensor 114 connected to said central processing unit 112. Typically, the temperature sensor is a die which is embedded in a sensor package. In operation, the central processing unit 112 may execute a computer program in accordance with the present disclosure. The computer program may have been stored in a memory unit which may be embedded in, or external to, the central processing unit 112. The temperature sensor 114 may perform repeated temperature measurements. The central processing unit 112 may communicate with the temperature sensor 114 in order to retrieve measured temperature values and store them in the memory unit, for example, which may be used as a working memory for performing calculations.

The calculation of the ambient temperature may be based on Newton's law of cooling. According to Newton's law of cooling, the rate of change of temperature of an object is proportional to the difference between the ambient temperature and its own temperature. This may be described as an equation, where T_{A} is the ambient temperature, T is the current temperature of the object, and k is a constant:

$$\frac{d T}{d t} = - k ( {T}_{A} - T )$$

Expanding on the equation gives:

$$\frac{d T}{d t} = - k ( {T}_{A} - T )$$

$$\int \frac{1}{{T}_{A} - T} d T = \int ( - k ) d t$$

$$ln ( {T}_{A} - T ) = - kt + ln ( c )$$

$$\frac{{T}_{A} - T}{c} = {e}^{- kt}$$

$${T}_{A} - T = c {e}^{- kt}$$

Applying the initial condition for (0,T₀), i.e. the initial temperature T₀ of the object at time instant 0, gives:

c=T_{A}−T₀

T=T_{A}−(T_{A}−T₀)e^{-kt}

Thus, from Newton's law of cooling, a formula is derived which defines the current temperature of an object (T) as a function of the ambient temperature (T_{A}), the initial temperature of the object (T₀) and time. In the case of a semiconductor-based temperature sensor, both the sensor package (in which the sensor die is embedded) and the printed circuit board (PCB) on which the sensor package is mounted may influence the temperature of the sensor die. Both objects, i.e. the sensor package and the PCB on which it is mounted, undergo temperature changes due to changes in the temperature of the ambient air. Through experiments, it was found that most thermal response curves can be described in the form Tsensor≈α(Tpackage)+β(Tpcb), wherein Tsensor is the current temperature of the sensor die (i.e. the current temperature value measured by the sensor), Tpackage is the current temperature of the sensor package, and Tpcb is the current temperature of the printed circuit board on which the sensor package is mounted. Thus, the last equation above can be rewritten as follows:

Tsensor=α[T_{A}−(T_{A}−T₀)e^{-k}^{₂}^{t}]+β[T_{A}−(T_{A}−T₀)e^{-k}^{₂}^{t}]

It is noted that the initial temperature of the sensor package is assumed to be the same as the initial temperature of the PCB and the initial temperature of the sensor die. That is to say, it is assumed that, at time instant 0, the sensor die, the sensor package and the PCB have temperature value T₀. Ideally, the initial condition is a condition wherein the temperature is at rest and preferably on the verge of transition. In this state, the temperatures of the die, the sensor package and the PCB are approximately the same. Any known method for detecting an initial condition may be used in combination with the presently disclosed method. Such methods include, without limitation, regular sampling of temperature changes, temperature trending detection techniques and edge detection techniques. Finally, rearranging the terms, the ambient temperature T_{A} can be calculated as follows:

$${T}_{A} = \frac{{T}_{sensor} - {T}_{0} {e}^{- {k}_{2} t} + α {T}_{0} ( {e}^{- {k}_{2} t} - {e}^{- {k}_{1} t} )}{1 - {e}^{- {k}_{2} t} + α ( {e}^{- {k}_{2} t} - {e}^{- {k}_{1} t} )}$$

wherein k₁ is a constant indicative of the thermodynamic properties of the sensor package, k₂ is a constant indicative of the thermodynamic properties of the next significant influence, i.e. the printed circuit board, and α=1−β. The constant α is a ratio which reflects the respective contributions of the influence of the sensor package and the influence of the printed circuit board on the temperature of the sensor die (Tsensor).

The inventors have found by experiment that this method of approximating the ambient temperature significantly reduces the response time. The coefficients k₁, k₂ and α may be sufficient to describe the thermal characteristics of the temperature sensor inside the casing of the mobile device. In order to calibrate the method for use in, for example, a mobile phone, the nominal k₁, k₂ and α coefficients may have to be established via experiments. This may be done as follows. First, temperature values may be measured and recorded in a log file. Then, the rate of change may be determined and curve-fitted to find the nominal values of k₁, k₂ and α for the mobile phone. Having established the nominal values of k₁ and k₂, some degree of freedom may be added to k₂. The nominal value of k₂ may be adjusted by estimation—for example by estimating it as a percentage of the nominal value of k₂—or by further experimentation, for example by subjecting the mobile phone to extreme thermal conductivities.

It is noted that further influences on the temperature of the sensor die (Tsensor) may also be taken into account. For example, the skilled person will appreciate that it is possible, and that it may sometimes be desirable, to take the influence of the casing of the mobile device on the temperature of the sensor die into account, in addition to the influence of the sensor package and the influence of the printed circuit board. In that case, the current temperature of the sensor die (Tsensor) may be expressed by Tsensor≈α(Tpackage)+β(Tpcb)+γ(Tcasing), and the above-described formula for calculating the ambient temperature (T_{A}) may be changed accordingly.

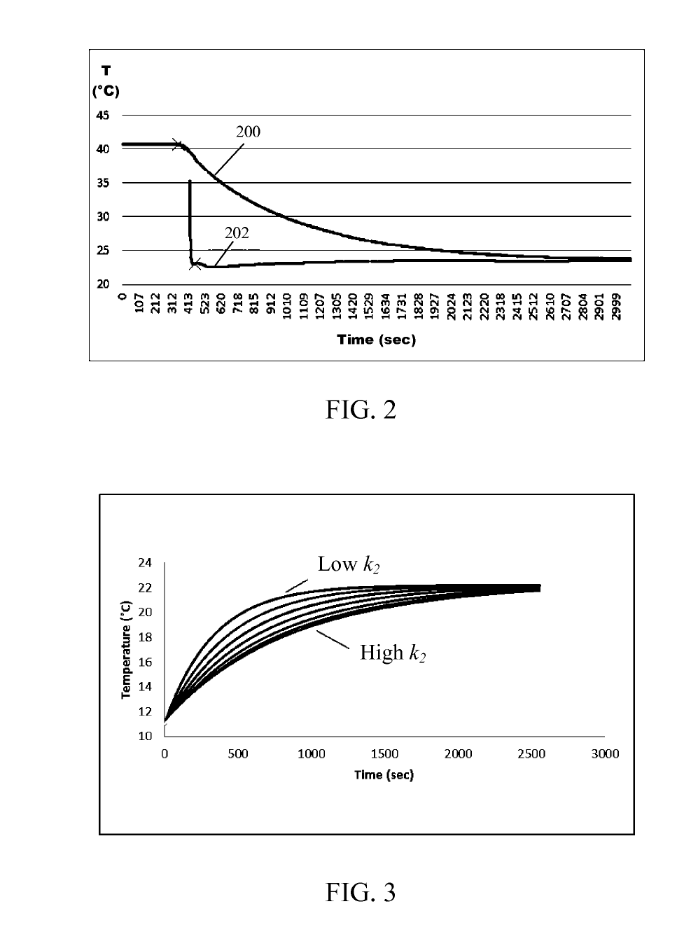

FIG. 2 illustrates the effect of applying a method of operating a mobile device of the kind set forth. In this example, the ambient temperature suddenly drops from above 40° C. to below 25° C. The upper line 200 shows the ‘raw’ temperature values measured by the temperature sensor. The lower line 202 shows the estimated ambient temperature, i.e. the calculated ambient temperature in accordance with the presently disclosed method. The figure shows that the estimation result is available approximately 2500 seconds earlier than the raw temperature value that corresponds to the new ambient temperature.

According to one or more illustrative embodiments, a plurality of thermal profiles may be defined, each thermal profile corresponding to a predefined environmental condition and including a reference value for a rate of change of temperature values. Furthermore, an environmental condition around the mobile device may be determined by means of the following steps. The rate of change of a plurality of measured temperature values may be compared with all reference values. Next, the reference value which is closest to the rate of change of the measured temperature values may be selected. Then, the thermal profile which includes said reference value may be selected. Finally, it may be concluded that the environmental condition around the mobile device is the same as the predefined environmental condition which corresponds to the selected thermal profile. These steps may be performed by the processing unit, again, for example, by executing a computer program that performs said steps. In this way, the mobile device may indicate to a user which environmental condition exists around the mobile device.

In accordance with the present disclosure, the rate of temperature change of a device with an embedded temperature sensor may be described by a set of constants. Such a set of constants may define a thermal profile of a device. A thermal profile may be based on at least three constants: α, k₁, k₂. Different thermal profiles may correspond to different environmental conditions, such as weather conditions or surrounding material conditions. For example, in a stationary air environment, the device may be described by a certain set of constants. When the environment changes, for example due to convection or the proximity of a metallic surface, the device may be described by a different set of constants, i.e. a different rate of temperature change. In accordance with the present disclosure, therefore, thermal profiles including reference values for the rate of temperature change may be defined. The actual rate of temperature change, based on measured temperature values, may then be compared with these reference values, in order to find the above-mentioned closest match. A plurality of thermal profiles may be defined for a device: one for air with convection, one for the proximity of a metallic surface, one for the proximity of a wooden surface, and another one for holding the device in a hand, for example. In an illustrative implementation, a short history of temperature values may be kept, for example. Then, the history of temperature changes may be matched to a set of curves described by different sets of thermal constants, or, using the history of temperature values, the thermal constants of the curve may be calculated and compared to a set of pre-calibrated constants that best suggest the environmental condition which influences the temperature readings.

FIG. 3 illustrates the effect of varying environmental conditions on temperature change. An environmental condition such as wind (higher air convection) is best represented by a low value of constant k₂ and leads to shorter response time, i.e. it takes a relatively small amount of time before the raw temperature values measured by the temperature sensor match the actual new ambient temperature. When the object is close to a metallic surface (higher heat conduction), the constant k₂ may have a medium value, and the response time is moderate. When the object is, for instance, wrapped in a bag, which inhibits the convection, the constant k₂ may have a relatively high value, and the response time is long.

It is noted that the embodiments above have been described with reference to different subject-matters. In particular, some embodiments may have been described with reference to method-type claims whereas other embodiments may have been described with reference to apparatus-type claims. However, a person skilled in the art will gather from the above that, unless otherwise indicated, in addition to any combination of features belonging to one type of subject-matter also any combination of features relating to different subject-matters, in particular a combination of features of the method-type claims and features of the apparatus-type claims, is considered to be disclosed with this document.

Furthermore, it is noted that the drawings are schematic. In different drawings, similar or identical elements are provided with the same reference signs. Furthermore, it is noted that in an effort to provide a concise description of the illustrative embodiments, implementation details which fall into the customary practice of the skilled person may not have been described. It should be appreciated that in the development of any such implementation, as in any engineering or design project, numerous implementation-specific decisions must be made in order to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill.

Finally, it is noted that the skilled person will be able to design many alternative embodiments without departing from the scope of the appended claims. In the claims, any reference sign placed between parentheses shall not be construed as limiting the claim. The word “comprise(s)” or “comprising” does not exclude the presence of elements or steps other than those listed in a claim. The word “a” or “an” preceding an element does not exclude the presence of a plurality of such elements. Measures recited in the claims may be implemented by means of hardware comprising several distinct elements and/or by means of a suitably programmed processor. In a device claim enumerating several means, several of these means may be embodied by one and the same item of hardware. The mere fact that certain measures are recited in mutually different dependent claims does not indicate that a combination of these measures cannot be used to advantage.

### LIST OF REFERENCE SIGNS

100 method of operating mobile device
102 measure initial temperature value
104 measure current temperature value
106 calculate ambient temperature
108 mobile device
110 printed circuit board
112 central processing unit
114 temperature sensor
200 measured temperature values
202 calculated ambient temperature

1. A method of operating a mobile device, wherein:
a temperature sensor comprised in said mobile device measures, at a first time instant, an initial temperature value;
the temperature sensor measures, at a second time instant, a current temperature value;
a processing unit comprised in said mobile device calculates an ambient temperature around the mobile device in dependence on the initial temperature value, the current temperature value and at least one further value which is indicative of a thermal influence of a mobile device component on the temperature sensor.

2. A method as claimed in claim 1, wherein the processing unit calculates the ambient temperature in dependence on a further value that is indicative of a thermal influence of a sensor package which includes the temperature sensor.

3. A method as claimed in claim 2, wherein the processing unit calculates the ambient temperature in dependence on a further value that is indicative of a thermal influence of a printed circuit board on which the sensor package is mounted.

4. A method as claimed in claim 1, wherein the processing unit calculates the ambient temperature in dependence on a further value that is indicative of a thermal influence of a casing of the mobile device.

5. A method as claimed in claim 1, wherein the processing unit calculates the ambient temperature further in dependence on a ratio which is indicative of respective contributions of thermal influences of different mobile device components on the temperature sensor.

6. A method of operating a mobile device, wherein:
a temperature sensor measures a plurality of temperature values; and
a processing unit determines an environmental condition around the mobile device by:
determining a rate of change of the measured temperature values,
comparing the determined rate of change with a plurality of different reference values corresponding to predefined environmental conditions,
selecting the reference value which is closest to the determined rate of change, and
concluding that the environmental condition around the mobile device is the same as the predefined environmental condition which corresponds to the selected reference value.

7. A method as claimed in claim 6, wherein each of the plurality of different reference values is included in one of a plurality of thermal profiles.

8. A method as claimed in claim 6, wherein at least one predefined environmental condition corresponds to a weather condition and/or at least one predefined environmental condition corresponds to a surrounding material condition.

9. A computer program product comprising executable instructions stored on a non-transient computer readable medium which, when being executed by a processing unit, carry out or control a method as claimed in claim 1.

10. A mobile device comprising:
a temperature sensor being arranged to measure, at a first time instant, an initial temperature value and, at a second time instant, a current temperature value;
a processing unit being arranged to calculate an ambient temperature around the mobile device in dependence on the initial temperature value, the current temperature value and at least one further value which indicative of a thermal influence of a mobile device component on the temperature sensor.

11. A mobile device as claimed in claim 10, wherein the processing unit is arranged to calculate the ambient temperature in dependence on a further value that is indicative of a thermal influence of a sensor package which includes the temperature sensor.

12. A mobile device as claimed in claim 11, wherein the processing unit is arranged to calculate the ambient temperature in dependence on a further value that is indicative of a thermal influence of a printed circuit board on which the sensor package is mounted.

13. A mobile device as claimed in claim 10, wherein the processing unit is arranged to calculate the ambient temperature in dependence on a further value that is indicative of a thermal influence of a casing of the mobile device.

14. A mobile device as claimed in claim 10, wherein the processing unit is arranged to calculate the ambient temperature further in dependence on a ratio which is indicative of respective contributions of thermal influences of different mobile device components on the temperature sensor.

15. A mobile device comprising a temperature sensor and a processing unit, wherein:
the temperature sensor is arranged to measure a plurality of temperature values; and
the processing unit is arranged to determine an environmental condition around the mobile device by:
determining a rate of change of the measured temperature values,
comparing the determined rate of change with a plurality of different reference values corresponding to predefined environmental conditions,
selecting the reference value which is closest to the determined rate of change, and
concluding that the environmental condition around the mobile device is the same as the predefined environmental condition which corresponds to the selected reference value.
